(19) United States
(12) Patent Application Publication
(10) Pub. No.: US 2010/0238022 A1
(43) Pub. Date: Sep. 23, 2010

(54) PET DETECTION SYSTEM AND METHOD

(76) Inventors: CINDY L. AU, Honolulu, HI (US); Kerstyn Au, Honolulu, HI (US)

Correspondence Address: LAW OFFICE OF JERRY D. HAYNES , P.A, P.O. Box 350392, Fort Lauderdale, FL, 33335, US

(21) Appl. No.: 12/406,116

(22) Filed: Mar. 18, 2009

(51) Int. Cl. G08B 1/08

(52) U.S. Cl. 340/539.13

(57) ABSTRACT

The present invention relates to a pet location and detection system and method that includes: an embedded microchip, where said microchip is embedded under the skin of a pet and emits a signal; a pet detection unit, which includes a power supply, a processor and a memory, where the pet detection unit is capable of receiving the signal from the microchip; and software residing on the pet detection unit, where the software enables the functions related to the pet detection unit. The pet detection unit according to the present invention detects the distance between the pet detection unit and the microchip. The pet detection unit includes a speaker for an audible alert, where the pet detection unit emits an audible alert if the pet wanders outside a pre-set distance. The pet location system also includes a video screen that displays a mapping grid showing the pet's location.

### BACKGROUND OF THE INVENTION

1. Field of Invention

The present invention relates to a pet detection system that utilizes electronic signaling to locate a lost pet.

2. Description of Related Art

Pet owners are always concerned with the safety and well being of their pet. The location of one's pet is particularly important when the pet is allowed to go outside the confines of the home or fenced yard. Normally, if the owner is with the pet, the owner may utilize a leash in order to keep the pet within their control and reach. Nonetheless many owners unleash their pet while outdoors to allow the pet to run about or to relieve themselves of their responsibility of containing the pet on a leash.

On occasion when pet owners leave their home they leave their pets outside unattended or within a fenced yard. On occasion some pets have been known to penetrate the confines of the yard and roam about the neighborhood freely. Consequently there are times when a pet may run astray, become lost and the pet owner is unable to locate the pet. In the past pet owners options for finding their pet was limited. Owners would have to request dog catchers or the Humane Society to search for their lost pet or the owners would have to go on a search mission to locate their pet.

Recently electronic systems have been implemented to assist pet owners in finding and retrieving lost or missing pets. A number of the systems available utilize GPS technology and satellite technology in order to maintain the location of a pet. Some of the systems provide an electronic sensing device on a pet's collar which is constant communication with the satellite and therefore provides a location and retrieving system based upon the communications between the device on the pet and the satellites. Other systems involved transmitters that transmit a signal to a unit where the pet owner may be able to track the pet based upon received signal strength between the transmitter and receiver.

A need still exists for further development of pet detection systems that provide a means to alert the owner if a pet wanders outside a pre-determined parameter and a means to track the pet once the pet breaches the parameter.

### SUMMARY OF THE INVENTION

The present invention relates to a pet location and detection system comprising: an embedded microchip, where said microchip is embedded under the skin of a pet and emits a signal; a pet detection unit, which includes a power supply, a processor and a memory, where the pet detection unit is capable of receiving the signal from the microchip; and software residing on the pet detection unit, where the software enables the functions related to the pet detection unit. The pet detection unit according to the present invention detects the distance between the pet detection unit and the microchip. The pet detection unit includes a speaker for an audible alert, where the pet detection unit emits an audible alert if the pet wanders outside a pre-set distance.

The pet location system according to the present invention also includes a video screen that displays a mapping grid. The pet's location may be depicted on the mapping grid. The present invention further includes a method of locating a pet comprising the steps of: embedding a microchip under a pet's skin; emitting a constant signal from the microchip; detecting the signal using a pet detection unit; and programming the pet detection unit using software residing on memory within the pet detection unit.

### BRIEF DESCRIPTION OF DRAWINGS

FIG. 1A shows a top view of a pet detection unit according to the present invention.

FIG. 1B shows a rear view of the pet detection unit according to the present invention.

FIG. 2 shows a prospective view of the pet detection unit in operation.

### DETAILED DESCRIPTION

The present invention provides a pet detection unit and system that utilizes a signal emitted from a microchip inserted within or under the pet's skin that sends a continuous signal to a pet detection unit. The present invention is able to detect the location of a pet and display the pet's location on a viewing screen which depicts a map of a local area.

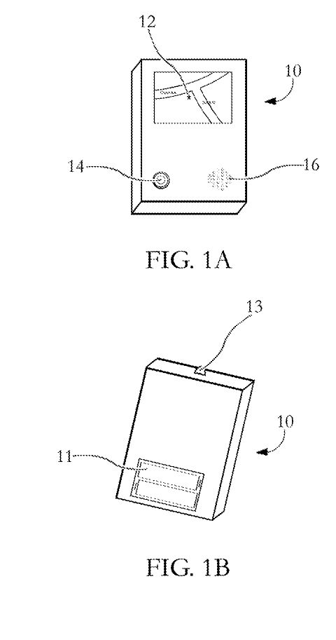

FIG. 1A depicts a front view of a Pet Detection Unit 10 according to the present invention. As contemplated by the present invention, the Pet Detection Unit 10 includes a Display Screen 12, a Power Button 14 and a Speaker 16. The components provide the means to alert an owner of a wandering pet and locate the pet's location. The pet detection unit includes software that controls the functionality related to the pet detection unit. The software resides in a storage unit not shown inside of the pet detection unit and includes a processor. As contemplated by the present invention a pet would have an embedded microchip underneath his skin, which transmits a constant signal that may be detected by the Pet Detection Unit 10. The Pet Detection Unit 10 may be set to alert the owner if the pet should wander outside a pre-set parameter. This pre-set parameter may be set by the owner and provide the owner with an instant audible alert that the pet has breached the pre-set parameters. The audible alert may be heard through Speaker 16.

The Pet Detection Unit 10 includes the Screen 12, which depicts a street view of the local area of where a pet may be located. This screen view may be updated by the pet owner as the pet moves from location to location. In one exemplary embodiment, the owner may desire the pet to remain within a one square mile area or less depending on the parameters set by the owner. Once the owner receives an alert that the pet may have wandered beyond the pre-set parameter then the owner may view on the screen the pet's location which will be depicted on Screen 12. The audio alert would remain constant until the owner was within a certain parameter and distance of the pet being sought.

The Pet Detection Unit 10 receives power through a battery as depicted in FIG. 1B where a Battery Compartment 11 is shown. A Sensor 13 on the Pet Detection Unit 10 receives the signals transmitted by a microchip within the pet.

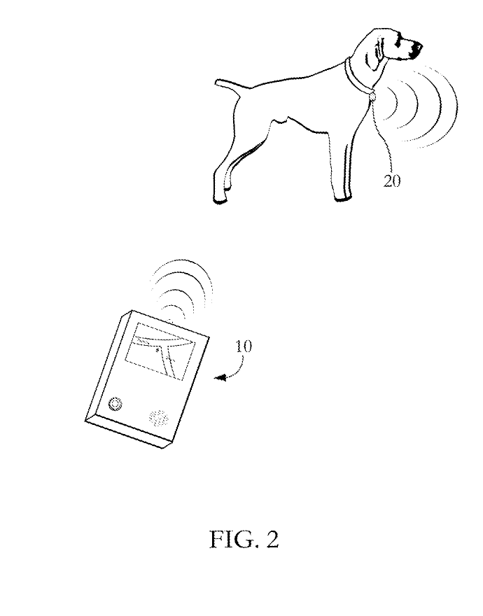

As shown in FIG. 2 the pet has the Microchip 20 lodged underneath the skin although not visible which transmits a constant signal. This constant signal is picked up by the Pet Detection Unit 10 constantly and as stated above an alert is sounded when the microchip is outside of the pre-determined distance programmed within the pet detection unit.

The pet detection unit according to the present invention provides the user with a system and method to locate a pet within a given parameter. The pet detection unit also provides the owner with a means to control the set parameters of the unit itself and it gives the owner a clear depiction of where the pet is located geographically via the Screen 12. This pet detection system and method alleviates problems associated with trying to locate lost pets and provides the owners with peace of mind as to their pet's location at all times.

What is claimed is:

1. A pet location and detection system comprising:
a. an embedded microchip, where said microchip is embedded under the skin of a pet and emits a signal;
b. a pet detection unit, which includes a power supply, a processor and a memory, where the pet detection unit is capable of receiving the signal from the microchip; and
c. software residing on the pet detection unit, where the software enables the functions related to the pet detection unit.

2. The pet location system according to claim 1, where the pet detection unit detects the distance between the pet detection unit and the microchip.

3. The pet location system according to claim 2, where the pet detection unit includes a speaker for an audible alert.

4. The pet location system according to claim 3, where the pet detection unit emits an audible alert if the pet wanders outside a pre-set distance.

5. The pet location system according to claim 1, where the pet detection unit includes a video screen, where the video screen displays a mapping grid.

6. The pet location system according to claim 5, where the pet location is depicted on the mapping grid.

7. A method of locating a pet comprising the steps of:
a. embedding a microchip under a pet's skin;
b. emitting a constant signal from the microchip;
c. detecting the signal using a pet detection unit; and
d. programming the pet detection unit using software residing on memory within the pet detection unit.

8. The method according to claim 7, further comprising the steps of:
a. setting distance parameters within the pet detection unit; and
b. initializing an audible alert when said pet breaches those parameters.

9. The method according to claim 7, further comprising the step of:
a. displaying a mapping grid on a viewing screen of the pet detection unit; and
b. providing a pinpoint location of the pet on the mapping grid.
